(19) United States
(12) Patent Application Publication
(10) Pub. No.: US 2003/0145939 A1
(43) Pub. Date: Aug. 7, 2003

(54) Dual die bonder for a semiconductor device and a method thereof

(76) Inventors: Seung Chul Ahn, Cheonan-city (KR); Hyeong Seob Kim, Cheonan-city (KR); Kyoung Bok Cho, Cheonan-city (KR); Sung Bok Hong, Cheonan-city (KR)

Correspondence Address: HARNESS, DICKEY & PIERCE, P.L.C., P.O. BOX 8910, RESTON, VA, 20195, US

(21) Appl. No.: 10/247,316

(22) Filed: Sep. 20, 2002

(30) Foreign Application Priority Data
Feb. 6, 2002 (KR) 2002-0006766

(51) Int. Cl. B32B 31/00

(52) U.S. Cl. 156/235; 156/556

(57) ABSTRACT

A dual die bonder device having two die-bonding sections and a transfer rail is disclosed. As a substrate moves along the transfer rail, each die-bonding section performs separate die-bonding processes, one process utilizing a liquid adhesive and one process utilizing an insulating adhesive tape. In the first die-bonding section, the liquid adhesive is supplied to a die-bonding area of the substrate, and a first semiconductor die is bonded onto the liquid adhesive. In the second die-bonding section, the insulating adhesive tape is supplied to either the first semiconductor die or to another die-bonding area of the substrate, and a second semiconductor die is bonded onto the insulating adhesive tape. A method of dual bonding a first semiconductor die and a second semiconductor die is also disclosed.

### CROSS REFERENCE TO RELATED APPLICATIONS

This U.S. non-provisional application claims priority under 35 U.S.C. §119 to Korean Patent Application No. 2002-0006766 filed Feb. 6, 2002, the contents of which are incorporated by reference.

### BACKGROUND OF THE INVENTION

1. Field of the Invention

The present invention relates to an apparatus for use in the manufacture of a semiconductor device. In particular, the present invention relates to a dual die bonder device by which two semiconductor dies are bonded to a substrate through different mediums of adhesion and a method of bonding two semiconductor dies using different mediums of adhesion.

2. Description of the Related Art

In the manufacture of semiconductor devices, die bonding is the step of attaching a semiconductor die, often referred to as a chip, to a substrate such as a lead frame, a printed circuit board, or a flexible circuit tape. A typical medium of adhesion used to bond the die and the substrate is a liquid adhesive that possesses electrical conductivity. Suitable examples of such liquid adhesives used in conventional processes include Ag-epoxy, Ag-glass, and solder. In conventional die bonding, the liquid adhesive is first dispensed onto the substrate, the die is placed on the liquid adhesive, and pressure is then applied.

In certain situations, die bonding requires an insulating adhesive for a specific die. For example, when two or more dies are bonded to a single substrate, an insulating adhesive is needed to electrically insulate the individual dies. In this case, the use of a liquid insulating adhesive has several drawbacks, including poor insulating capability. As a result, a tape-type insulating adhesive is typically used.

Referring to FIG. 1, a schematic configuration of a semiconductor device 10 using an insulating adhesive tape 59 is shown. As illustrated in FIG. 1, a first semiconductor die 42 is bonded to a substrate 12 by a liquid adhesive 32, and a second semiconductor die 62 is bonded to the first semiconductor die 42 by an insulating adhesive tape 59. In another example, the second semiconductor die 62 can be disposed beside the first die 62 and be directly bonded to the substrate 12 by the insulating adhesive tape 59. No matter what the second die 62 is bonded to, the first and second dies 42 and 62 are electrically insulated from each other by the insulating adhesive tape 59. After die bonding, the semiconductor dies 42 and 62 are electrically connected to the substrate 12 by metal wires (not shown) and then encapsulated with an encapsulant (not shown) such as an epoxy molding compound.

When the insulating adhesive tape 59 is used along with the liquid adhesive 32, separate die bonders should be employed because of the different adhesive mediums. Unfortunately, having two separate die bonders causes an enlargement of the space occupied by the die bonders, a need for additional equipment to transfer the substrate between the die bonders, and an increase in time required for the die bonding. It is therefore desirable to provide a die bonder device and method for bonding two dies with two different mediums of adhesion that overcomes the disadvantages of the prior art.

### SUMMARY OF THE INVENTION

Accordingly it is an object of the present invention to provide a dual die bonder device for a semiconductor device that overcomes the disadvantages of the prior art.

To accomplish the above objective, there is provided a dual die bonder for a semiconductor for bonding a first semiconductor die and a second semiconductor die. The dual die bonder according to the present invention includes a transfer rail configured to transfer a substrate having one or more die-bonding areas, a first die-bonding section which is located in the first half of the transfer rail to die bond the first semiconductor die by using a liquid adhesive, and a second die-bonding section located in the second half of the transfer rail to die bond the second semiconductor die by using an insulating adhesive tape.

In the dual die bonder device of the present invention, the first die bonding section may include a liquid adhesive provider to supply liquid adhesive onto the die bonding areas of the substrate. The first die-bonding section may further include a first die-bonding tool to pick up the first semiconductor die from a first wafer and attach the first semiconductor die onto the liquid adhesive on the substrate. Also, the first die-bonding section may include a first wafer table to support the wafer.

In addition, the second die bonding section may include an adhesive tape provider and a tape-attaching tool. The adhesive tape provider supplies the insulating adhesive tape to the tape-attaching tool which attaches the insulating adhesive tape to the first semiconductor die on the substrate or to another die-bonding area of the substrate. Further, the second die-bonding section may include a second die-bonding tool to pick up the second semiconductor die from a second wafer and attach the second semiconductor die to the insulating adhesive tape on the substrate. The second die bonding section may also include a second wafer table to support the second wafer.

In at least one embodiment of the present invention, the adhesive tape provider has a reel on which the insulating adhesive tape is spooled, a pair of rollers by which the insulating adhesive tape is wound off the reel, a tape cutter which cuts the insulating adhesive tape, and a tape holder which holds the insulating adhesive tape while being cut.

In at least one embodiment of the present invention, the dual die bonder device may also include a first substrate magazine and a second substrate magazine. The substrates are located each end of the transfer rail to contain the substrate. In addition, the dual die bonder device may include a loader to supply the substrate from the first substrate magazine to the transfer rail and an unloader to supply the substrate from the transfer rail to the second substrate magazine. In addition, the dual die bonder may include a curing unit located at the end of the transfer rail near the unloader to harden the liquid adhesive and the insulating adhesive tape provided on the substrate.

In at least one embodiment of the present invention, the substrate may be a lead frame strip, a printed circuit board, or a flexible circuit tape. The liquid adhesive may be a conductive material such as Ag-epoxy, Ag-glass, or solder, or a non-conductive material such as silicone. Preferably, the insulating adhesive tape has a core layer of polyimide and top and bottom layers of an adhesive material. Alternatively, the insulating adhesive tape may be formed of a single polyimide layer having adhesive properties.

It is also an object of the present invention to provide a method of bonding two semiconductor dies using different mediums of adhesion that overcomes the disadvantages of the prior art.

### BRIEF DESCRIPTION OF THE DRAWINGS

The above object and advantages of the present invention will become more apparent by describing in detail preferred embodiments thereof with reference to the attached drawings in which:

FIG. 1 is a cross-sectional view showing a conventional semiconductor device using an insulating adhesive tape;

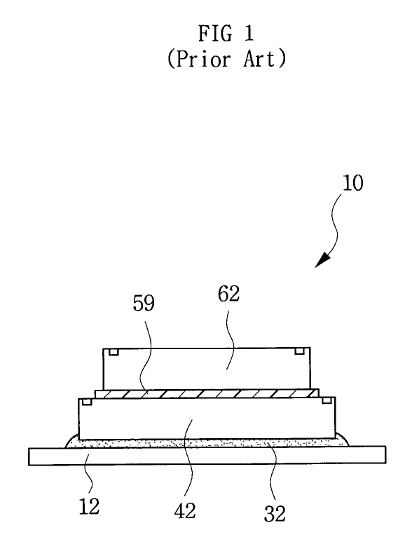

FIG. 2 is a block diagram of a dual die bonder device in accordance with a preferred embodiment of the present invention; and

FIG. 3 is a perspective view showing the dual die bonder device depicted in FIG. 2.

### DETAILED DESCRIPTION OF THE INVENTION

The present invention will be now described more fully hereinafter with reference to accompanying drawings. This invention may, however, be embodied in many different forms and should not be construed as limited to the embodiment set forth herein. Rather, this embodiment is provided so that this disclosure will be thorough and complete, and will fully convey the scope of the invention to those skilled in the art.

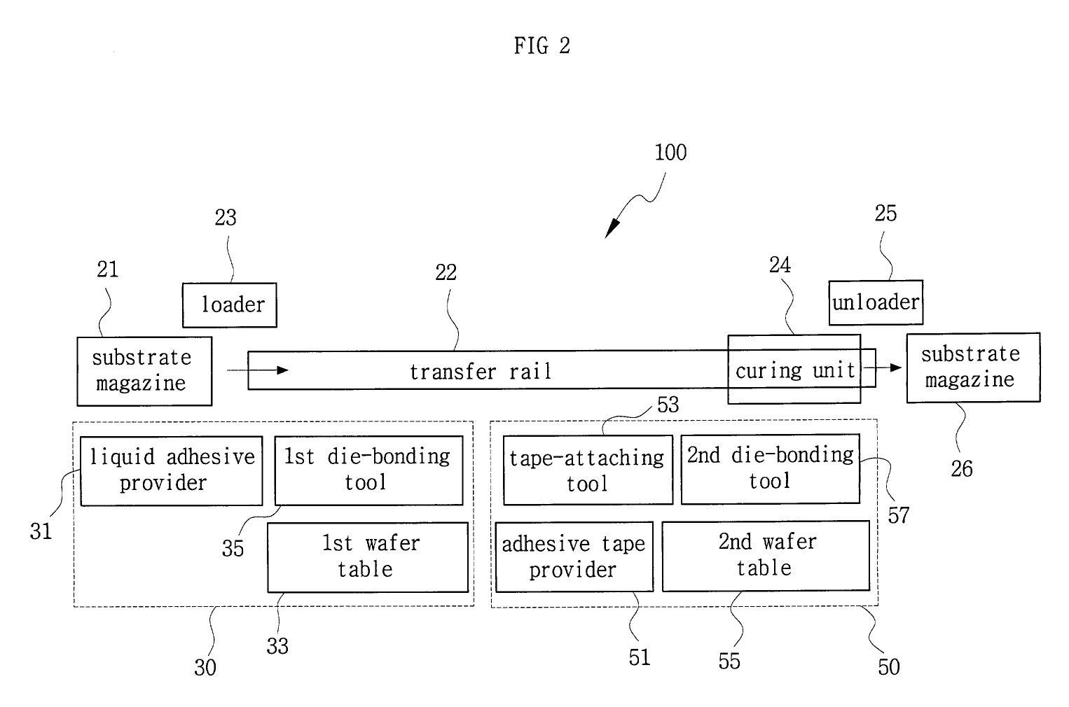

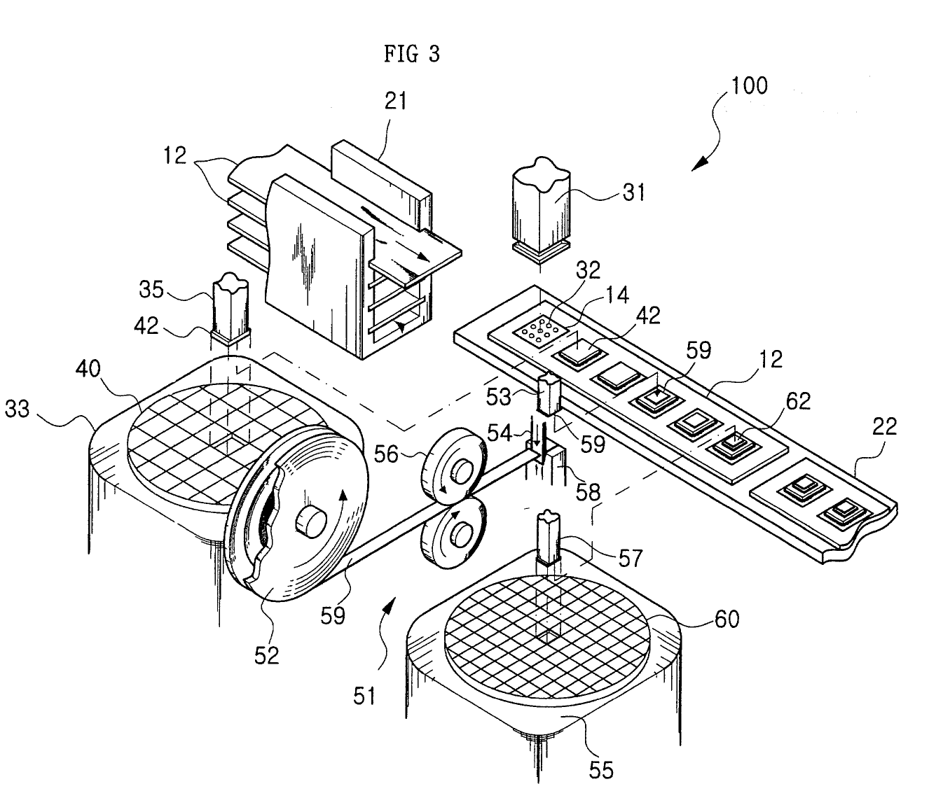

Referring to FIGS. 2 and 3, it can be seen that the dual die bonder 100 includes two die-bonding sections 30 and 50 located adjacent to each other and in close proximity. The first die-bonding section 30 performs a die bonding process using a liquid adhesive 32 and the second die-bonding section 50 performs a second die bonding process using an insulating adhesive tape 59. The dual die bonder 100 includes a transfer rail 22 running parallel with the die-bonding sections 30 and 50. Therefore, while a substrate 12 moves along the transfer rail 22, two different die bonding processes can be carried out in sequence without delay.

Preferably, substrate magazines 21 and 26 are provided at both ends of the transfer rail 22. The first magazine 21 is located at the beginning of the first die bonding section and contains empty substrates. The second magazine 26 is located at the end of the second die bonding section and contains die-bonded substrates. Typically, the substrate 12 has one or more die bonding areas 14. Preferably, the substrate 12 is a lead frame strip, a printed circuit board, or a flexible circuit tape, which is identifiable to those of skill in the art. The shape of magazines 21 and 26 is dependent on the type of substrate chosen.

In at least one embodiment of the invention, the substrates 12 are supplied one by one from the first magazine 21 to the transfer rail 22 by the action of a loader 23, and from the transfer rail 22 to the second magazine 26 by the action of an unloader 25. The transfer rail 22 conveys the substrate 12 one die bonding area at a time, thereby permitting sequential die bonding. A typical transferring machine such as a conveyor belt can be alternatively used instead of the transfer rail 22.

The first die-bonding section 30 is located in the first half of the transfer rail 22 and includes a liquid adhesive provider 31, a first wafer table 33, and a first die-bonding tool 35. For bonding the first die 42, the liquid adhesive provider 31 supplies the liquid adhesive 32 onto the die-bonding area 14 of the substrate 12 on the transfer rail 22. Preferably, the application of the liquid adhesive 32 is performed in a dotting manner. Preferably, the liquid adhesive 32 is a conductive material such as Ag-epoxy, Ag-glass, or solder, or a non-conductive material such as silicone.

In at least one embodiment of the invention, the first die 42 is supplied in the form of a first wafer 40 having a large number of first dies 42. When a first wafer 40 is placed on the first wafer table 33, the first die-bonding tool 35 picks up one of the first dies 42 from the first wafer 40 by a suction force and then places the die onto the liquid adhesive 32 on the die-bonding area 14 of the substrate 12. The first die-bonding tool 35 moves between the first wafer table 33 and the transfer rail 22 by the action of a moving arm (not shown). After the first die-bonding tool 35 has attached the first die 42 to the liquid adhesive 32, heat and pressure can be applied for better adhesion.

The second die-bonding section 50 is located in the second half of the transfer rail 22 and includes an adhesive tape provider 51, a tape-attaching tool 53, a second wafer table 55, and a second die-bonding tool 57. The adhesive tape provider 51 supplies the insulating adhesive tape 59 to the first die 42 so that the second die 62 can be attached thereto. Preferably, the insulating adhesive tape 59 is a two-sided adhesive tape having a core layer of polyimide and top and bottom layers of adhesive material. Alternatively, the insulating adhesive tape 59 may be formed of a single polyimide layer having adhesive properties.

In at least one embodiment of the invention, the adhesive tape provider 51 has a reel 52, a tape cutter 54, a pair of rollers 56, and a tape holder 58. The insulating adhesive tape 59 is spooled onto the reel 52. The insulating adhesive tape 59 is wound off the reel 52 by the pair of rollers 56 and is then fed to the tape cutter 54 and the tape holder 58. The tape cutter 54 cuts the insulating adhesive tape 59 into a piece of tape having a specific size.

During the cutting of the insulating adhesive tape 59, the tape holder 58 holds the insulating adhesive tape 59 by a suction force. The rollers 56 then move the insulating adhesive tape 59 a distance equal to the proper length for bonding first die 42 and second die 62. The position of the tape cutter 54 and the width of the reel 52 may be changeable depending on the size of the insulating adhesive tape 59 required for die bonding the first and second dies (42 and 62 respectively). The tape cutter 54 and the rollers 56 permit an effective and continuous supply of the insulating adhesive tape 59 for die bonding, thereby promoting efficiency of the entire die bonding process.

After the insulating adhesive tape 59 has been cut to a specific size, the tape-attaching tool 53 picks it up from the tape holder 58 by applying a suction force. The tape-attaching tool 53 then moves toward the substrate 12 on the transfer rail 22, stops applying the suction force, and attaches the insulating adhesive tape 59 onto the first die 42 previously bonded to the substrate 12. The second die 62 is then placed on the insulating adhesive tape 59 and bonded thereto.

Similar to the first die 42, the second die 62 is supplied in the form of a second wafer 60 having a large number of second dies 62. When the second wafer 40 is placed on the second wafer table 55, the second die-bonding tool 57 picks up one of the second dies 62 from the second wafer 60 by a suction force and then attaches it to the insulating adhesive tape 59 on the first die 42. The second die-bonding tool 57 moves between the second wafer table 55 and the transfer rail 22 by the action of a moving arm (not shown). After the second die-bonding tool 57 has attached the second die 62 to the insulating adhesive tape 59, heat and pressure can be applied for better adhesion.

In at least one preferred embodiment of the present invention, the dual die bonder 100 may also include a curing unit 24 disposed at the end of the transfer rail 22 near the unloader 25. The curing unit 24 is used to harden the liquid adhesive 32 and the insulating adhesive tape 59. Preferably, the curing time is about five to ten minutes. Unlike conventional die bonding process which perform separate curing steps for two different adhesive mediums, namely, the liquid adhesive and the adhesive tape, the present invention can perform a single curing step and thereby reduce the curing time.

The dual die bonder device according to the present invention can be used for dies with lateral configuration as well as dies with vertical configuration. In other words, in a lateral configuration, the second die is located beside the first die, not on the first die, and is directly bonded to a separate die-bonding area of the substrate by the insulating adhesive tape. In this example, the adhesive tape provider supplies the insulating adhesive tape to the substrate, not the first die.

As described above, the dual die bonder device of the present invention can perform in sequence two separate die-bonding processes using a liquid adhesive and an adhesive tape in a single apparatus, thereby promoting efficiency, improving productivity, and simplifying the manufacturing process. Because the two adhesive steps are performed in the same device, the dual die bonder device of the present invention requires less space and less time to perform the two separate adhesion processes. In addition, the dual bonder device of the present invention reduces manufacturing costs by providing a device capable of adhering two dies with two different mediums.

In the drawings and specification, there has been disclosed a typical preferred embodiment of the invention and, although specific terms are employed, they are used in a generic and descriptive sense only and not for purposes of limitation, the scope of the invention being set forth in the following claims.

What is claimed is:

1. A dual die bonder device for a semiconductor device having a first semiconductor die and a second semiconductor die, said dual die bonder device comprising:
a transfer rail configured to transfer a substrate having one or more die-bonding areas;
a first die-bonding section located in a first half of the transfer rail for die-bonding the first semiconductor die with a liquid adhesive; and
a second die-bonding section located in a second half of the transfer rail for die-bonding the second semiconductor die with an insulating adhesive tape.

2. The dual die bonder device of claim 1, wherein the first die-bonding section comprises a liquid adhesive provider for supplying the liquid adhesive onto the die-bonding areas of the substrate.

3. The dual die bonder device of claim 2, wherein the first die-bonding section further comprises a first die-bonding tool for transferring the first semiconductor die from a first wafer to the liquid adhesive supplied to the die-bonding areas of the substrate.

4. The dual die bonder device of claim 3, wherein the first die-bonding section further comprises a first wafer table for supporting the first wafer.

5. The dual die bonder device of claim 1, wherein the second die-bonding section comprises an adhesive tape provider and a tape-attaching tool, the adhesive tape provider supplying the insulating adhesive tape to the tape-attaching tool and the tape-attaching tool attaching the insulating adhesive tape onto the first semiconductor die on the substrate or another die-bonding area of the substrate.

6. The dual die bonder device of claim 5, wherein the second die-bonding section further comprises a second die-bonding tool for transferring the second semiconductor die from a second wafer onto the insulating adhesive tape.

7. The dual die bonder device of claim 6, wherein the second die-bonding section further comprises a second wafer table for supporting the second wafer.

8. The dual die bonder device of claim 5, wherein the adhesive tape provider includes a reel on which the insulating adhesive tape is spooled, a pair of rollers for removing the insulating adhesive tape from the reel, a tape cutter for cutting the insulating adhesive tape, and a tape holder for holding the insulating adhesive tape while cutting the insulating adhesive tape.

9. The dual die bonder device of claim 1, further comprising:
a first substrate magazine located at an end of the transfer rail in the first die bonding section; and
a second substrate magazine located at an end of the transfer rail in the second die bonding section;
wherein said first and second substrate magazine contain the substrate.

10. The dual die bonder device of claim 9, further comprising:
a loader configured to supply the substrate from the first substrate magazine to the transfer rail; and
an unloader configured to supply the substrate from the transfer rail to the second substrate magazine.

11. The dual die bonder device of claim 10, further comprising:
a curing unit located in close proximity to the unloader to harden the liquid adhesive and the insulating adhesive tape.

12. The dual die bonder device of claim 1, wherein the substrate is selected from the group consisting of a lead frame strip, a printed circuit board and a flexible circuit tape.

13. The dual die bonder device of claim 1, wherein the liquid adhesive is selected from the group consisting of a conductive material and a non-conductive material.

14. The dual die bonder device of claim 13, wherein the conductive material is selected from the group consisting of Ag-epoxy, Ag-glass and solder.

15. The dual die bonder device of claim 13, wherein the non-conductive material is silicone.

16. The dual die bonder device of claim 1, wherein the insulating adhesive tape is a two-sided adhesive tape.

17. The dual die bonder device of claim 16, wherein the insulating adhesive tape includes a core layer of polyimide and top and bottom layers of an adhesive material.

18. The dual die bonder device of claim 1, wherein the insulating adhesive tape is formed of a single polyimide layer having adhesive properties.

19. A method of dual bonding a first semiconductor die and a second semiconductor die comprising the steps of:
placing a first wafer having a plurality of first semiconductor dies on a first wafer table and a second wafer having a plurality of second semiconductor dies on a second wafer table;
placing a liquid adhesive on a die bonding area of a substrate located on a transfer rail in a first bonding area by a liquid adhesive provider;
transferring one of said first dies onto said liquid adhesive on said die bonding area by a die bonding tool;
moving said substrate along said transfer rail to a second bonding area;
attaching an insulating adhesive tape to the first semiconductor die or to said substrate by a tape attaching tool; and
transferring one of said second dies onto said insulating adhesive tape by a second die bonding tool.

20. The method of claim 19, further comprising the step of curing the liquid adhesive and insulating adhesive tape in a curing unit.

21. The method of claim 20, wherein said curing step occurs over a period of about 5 to 10 minutes.

22. The method of claim 21, further comprising the steps of heating and applying pressure to said first and second semiconductor dies after said transferring steps.

23. The method of claim 19, wherein said liquid adhesive is applied in a dotting manner.

24. The method of claim 19, wherein said first die bonding tool transfers said first semiconductor die and said second die bonding tool transfers said second semiconductor die by a suction force.

25. The method of claim 19, wherein said attaching step includes the steps of:
unwinding said insulating adhesive tape from a reel by a pair of rollers;
holding said insulating adhesive tape by a tape holder; cutting said insulating adhesive tape with a tape cutter; and
transferring said cut insulating adhesive tape to said tape attaching tool.
